(19) United States
(12) Patent Application Publication
(10) Pub. No.: US 2015/0129725 A1
(43) Pub. Date: May 14, 2015

(54) CLAMP AND CLAMP ASSEMBLY

(71) Applicant: Deere & Company, Moline, IL (US)

(72) Inventor: DAVID ERNESTO ZEDAN, Santa Catarina (MX)

(21) Appl. No.: 14/490,815

(22) Filed: Sep. 19, 2014

(30) Foreign Application Priority Data
Sep. 30, 2013 (DE) 102013219741.1

(51) Int. Cl. F16L 3/22; F16L 3/10

(52) U.S. Cl. CPC F16L 3/222; F16L 3/1091
USPC 248/67.5

(57) ABSTRACT

A clamping assembly includes a plurality of clamps for fastening hoses or cables on a frame structure. Each clamp has a cube-shaped body which surrounds a cylindrical hollow space or bore which extends through the body. The body includes a first and a second body part. Each body part has a separating surface on which a semi-cylindrical recess is formed. The body parts are joined to each other at their separating faces by means of a plug connection. Each body has plug pins on at least one side face and plug bores on an opposite side face.

### FIELD

The present disclosure relates to a clamp assembly for fastening hoses or cables to a frame structure.

### BACKGROUND

Different types of clamps or clamping units are known in the prior art with which hoses or cables are guided and fastened on a frame structure of vehicles or machines.

Known clamps or clamping units must normally be adapted anew to the existing hoses to be fastened and to the frame conditions so that the hoses or cables can be fastened securely with as little play as possible securely on the frame structure or on a component part or the like. It is thereby necessary to always take note of the structurally determined conditions which has the result that the clamps or clamping units require an individual construction and have to be adapted to the different hose diameters or cable diameters and to the number of hoses or cables which are to be fastened. At the same time stability criteria have to be observed. This mostly has the result that a clamp or clamping unit can often only be used individually and uniquely on a specific vehicle model or a specific machine. Engineering drawings thereby have to be drawn up anew since generally it is not possible to revert to already manufactured clamps or clamping units of other models. Furthermore clamps or clamping units comprising rubber holders which are connected to sheet metal casings or sheet metal holders are often used and are correspondingly unstable and are often deformed or bent through the forces acting on them. This often leads to problems with the fastening of the clamps or clamping units on a frame structure, since the hoses or cables which are to be fastened there can be under stress. It is generally not worthwhile to keep high numbers of parts since one and the same clamp or clamping unit is seldom to be used repeatedly. This leads as a rule to increased production costs.

The object of the present invention is seen in providing a clamp or clamping unit of the type mentioned at the beginning through which one or more of the aforementioned problems are overcome.

### SUMMARY

According to an aspect of the present disclosure, a clamp for a clamping unit for fastening hoses or cables on a frame structure comprises a cube-like body which peripherally surrounds a cylindrical hollow space which is open at its end faces, wherein the body can be divided into a first and a second body part wherein the body parts each have a separating surface on which a semi-cylindrical recess is formed and wherein the body parts can be connected to one another at their separating surfaces by means of a plug-fit connection and furthermore the body has plug pins on at least one side face extending in the longitudinal direction of the cylindrical hollow space, and plug bores on the side face opposite the at least one side face. The clamp can be used in this way to form a plurality of combination variations for a clamping device, wherein the number of clamps and size of the hollow spaces can be individually adapted. This leads to a low number of parts for a high number of differently configured clamping units. The structurally identical bodies can thereby be made significantly more cost-effectively in a correspondingly high number.

Plug pins can be formed either side of the semi-cylindrical recess at the separating surface of the one body part, and plug bores can be formed correspondingly arranged on the separating face of the other body part, wherein to connect the two body parts together the plug pins can be inserted into the plug bores. Assembling the clamps is thereby significantly easier.

The plug pins and the plug bores can be formed so that the plug pins snap into the plug bores, i.e. by way of example according to a method known as “snap-fit” (snap-fit connection or detent device). For this the plug pins can be formed by way of example with a ball head which can be pressed into a correspondingly designed plug bore. The plug pins can also be provided with a type of bead or barb at the pin end, wherein the plug pins are pushed into a correspondingly complementary designed plug bore and the bead or barb correspondingly enters into engagement or snap-fits with a shoulder formed in the plug bore opposite the bead or barb. The cohesion of these body parts and thus the stability overall of the clamp is increased through the snap-fit engagement. It is also conceivable to design the plug pins and plug bores purely cylindrical with corresponding press-fit connection.

The clamp is formed on one of the body parts, on the side faces adjoining the separating face at the sides and extending in the longitudinal direction of the cylindrical hollow space, with a recess, wherein a fastening means can be inserted in the recess in order to fasten the body on a frame structure. As fastening means can be used sheet metal strips, hoops, or U-brackets which engage in the recess and hold the body.

The recess can be designed as a slit and the fastening means can be designed as a double-angled retaining plate wherein one end of the retaining plate can be inserted into the recess and the other end can be fastened on a frame structure. It is also conceivable to replace the recess by one or more plug bores into which corresponding wire-like retaining brackets can be inserted by one of their ends and can be fastened at their other end to the frame structure. Ideally, but not absolutely essentially, the recess, or alternatively the corresponding plug bores, is/are located on an upper body part so that the lower body part is held together by the upper body part.

The semi-cylindrical recesses can be coated with an elastic and/or adhesive coating so that a certain tension is exerted on the hoses or cables which are to be fastened, and these are guided in a secure play-free seat. Breaks in the hoses or breaks in the cables, as well as the appearance of wear through abrasions on the hoses or cables which can arise through dynamic movements on the frame structure can thereby be avoided.

The aforementioned clamps can be used in a clamping unit for fastening hoses or cables on a frame structure, with several clamps arranged side by side or one above the other. Since several clamps arranged horizontally or vertically next to one another can be used, clamping units can be made up in versatile configurations which can be adapted to the individual needs and requirements, such as for example to the number of hoses and cables, as well as to their path on the frame structure.

In order to guarantee a sufficient stability when combining several bodies, these are provided with plug pins on at least one side face extending in the longitudinal direction of the cylindrical hollow space, and with plug bores on the side face opposite the at least one side face, wherein adjacent clamps are snap-fitted together along a side face provided with plug pins, and a side face provided with plug bores.

As already mentioned above, the plug pins and the plug bores can also here be designed so that the plug pins snap into the plug bores wherein also here the plug pins with ball-headed profiles or plug pins with a bead or barb can be inserted in correspondingly complementary designed plug bores. Cylindrically recessed press-fit connections can also be provided here as an alternative.

The clamps in their respective combinations in the clamping unit can have cylindrical hollow spaces with different diameters. The clamps can thereby be adapted to hoses and cables of different thicknesses. In this respect it is also conceivable to make the clamps with only one diameter size and to obtain the different diameters for different thickness hoses and cables by adding corresponding semi-cylindrical inserts in the recesses or by adding coatings of correspondingly different thickness in the recesses.

The clamping unit, consisting of one or more clamps, can be used in a frame structure with one or more hoses or cables extending along the frame structure, wherein the hoses or cables are fastened to the frame structure by being guided in the cylindrical hollow spaces of the respective bodies.

As already mentioned, a recess is formed on one of the body parts, on the side faces adjoining the separating face at the side and extending in the longitudinal direction of the cylindrical hollow space, wherein fastening means are provided which are inserted into the recess wherein the recess is preferably designed as a slit and the fastening means are designed as a double-angled retaining plate, wherein one end of the retaining plate is inserted in the recess and the other end is fixed on the frame structure. It is advantageous here that irrespective of the width and height of the clamping unit only the uppermost and outside clamps are each provided with a fastening so that only two retaining plates have to be fixed on the frame structure. Only a limited number of different types of retaining plates are thereby designed which only differ in length and are only to be adapted to the height of the clamping arrangement.

The clamp and clamping unit described above includes the use of several combinations fitted together in modular fashion wherein the individual modules (clamps) can be fitted together in a “snap-fit” like manner. The cost for engineering drawings which were to be prepared for designing new machines can thereby be minimized. Only the number of modules (clamps) which are to be used, and the arrangement of fastening bores for the said retaining plates on the frame structure need thereby be determined. Costs are further reduced since a number of similar clamps can be commissioned. Expensive laser-cutting processes for individually adapted clamps of the conventional structural type can be omitted. The clamping parts can be made for example by casting from hard plastics, so that a cost-effective mass production in the injection casting process is possible.

### BRIEF DESCRIPTION OF THE DRAWINGS

FIG. 1 is a perspective first side view of a clamp according to the invention;

FIG. 2 is a perspective second side view of the clamp of FIG. 1 with separated first and second clamping parts;

FIG. 3 is a side view of a first clamping arrangement;

FIG. 4 is a perspective side view of the first clamping arrangement of FIG. 3;

FIG. 5 is a side view of a second clamping arrangement;

FIG. 6 is a perspective side view of the second clamping arrangement of FIG. 5;

FIG. 7 is a perspective view of a section of a frame structure with clamping arrangements fastened thereon and with hoses or cables guided therein; and

FIG. 8 is an enlarged side view of a section of a clamp of FIGS. 1 and 2.

### DETAILED DESCRIPTION OF THE DRAWINGS

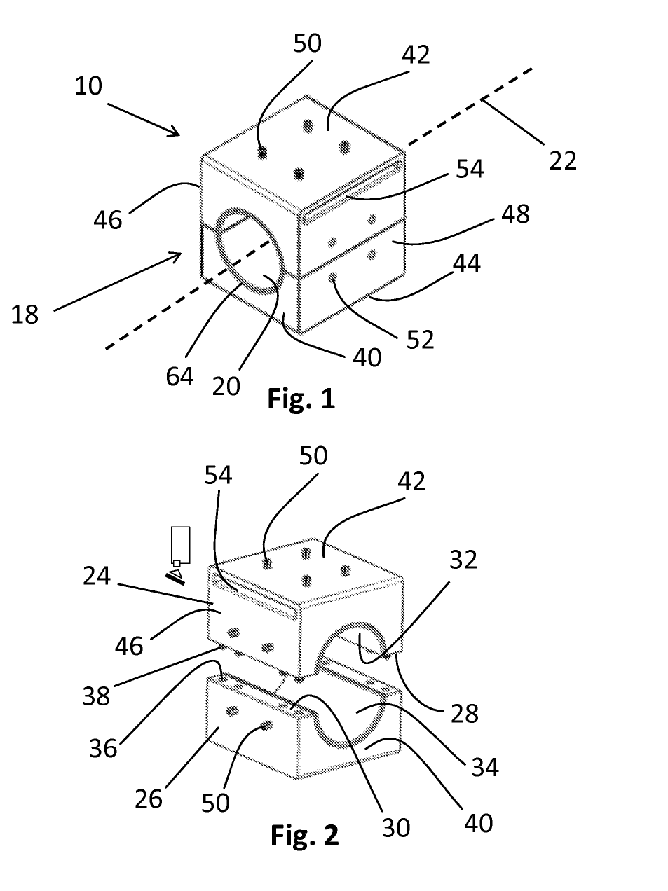

FIGS. 1 and 2 show a clamp 10 for a clamping assembly or unit 12 for fastening hoses or cables 14 on a frame structure 16. The clamp 10 includes a cube-like body 18, with six side faces, which peripherally surrounds a cylindrical hollow space or bore 20 with opened end faces. The body 18 is divided in half in a horizontal plane centrally to the cylindrical hollow space 20 along a central longitudinal axis 22 into an upper first and a lower second body part 24, 26. The body parts 24, 26 each have a separating surface 28, 30 on each of which a semi-cylindrical recess 32 and 34 is formed. The lower second body part 26 is provided on the separating surface 30 with plug recesses or bores 36 either side of the semi-cylindrical recess 34, and the upper first body part 24 is provided with plug posts 38 on the separating surface 28 either side of the semi-cylindrical recess 32. The plug posts 38 and the plug recess 36 form a push-fit connection wherein the plug posts 38 have ball-headed ends which engage in a corresponding engagement bore formed on the plug recesses 36. Other detent mechanisms can also be used here. To connect the two body parts 24, 26, the plug posts 38 can be pushed into the plug bores 36 whereupon they then engage there. With reference to FIG. 1 in which a front side 40 of the body 18 is shown with the open end side of the cylindrical hollow space 20, the side faces of the body 18 are named as follows: an upper side face 42, a lower side face 44 (concealed), a left side face 46 (concealed in FIG. 1 and visible in FIG. 2), and a right side face 48 (visible in FIG. 1 and concealed in FIG. 2). Further plug pins 50 are formed on the upper side face 42 and on the left side face 46 of the body 18, whilst corresponding plug bores 52 are formed on the lower side face 44 and on the right side face 48. Thus for each one side face 42, 46 formed with plug pins 50 the respectively opposite side face 44, 48 is provided with plug bores 52. Plug pins 50 and plug bores 52 are also designed here so that the plug pins 50 snap fit in the plug bores 52.

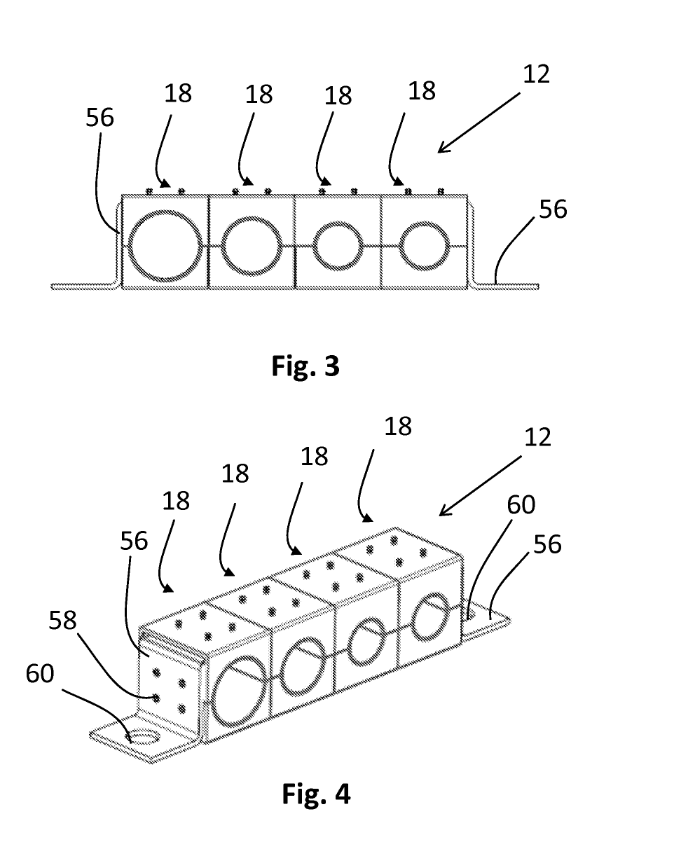

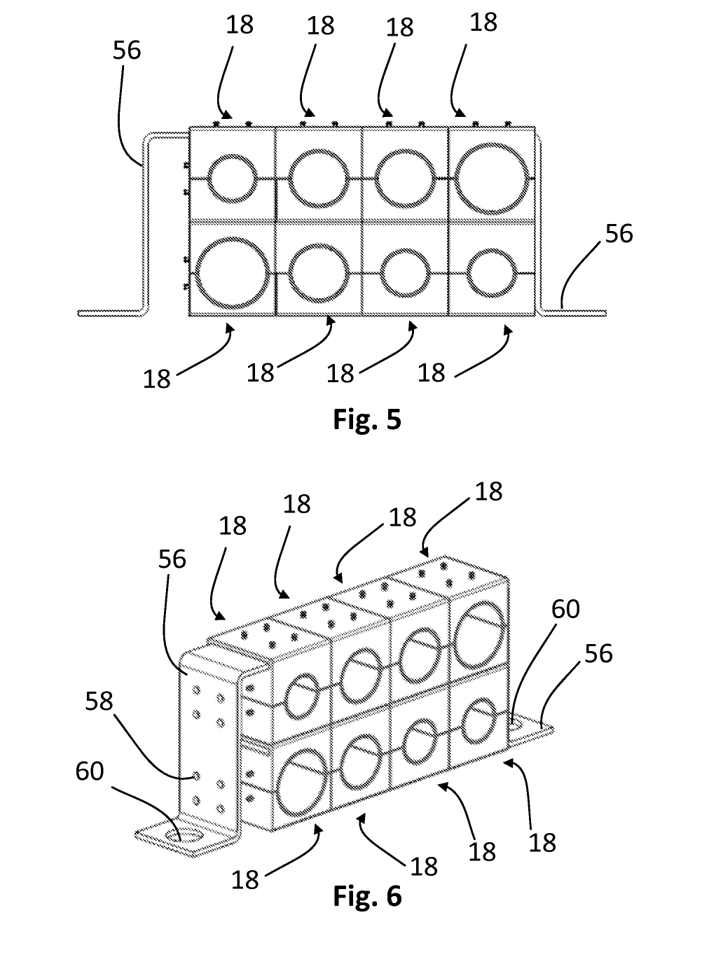

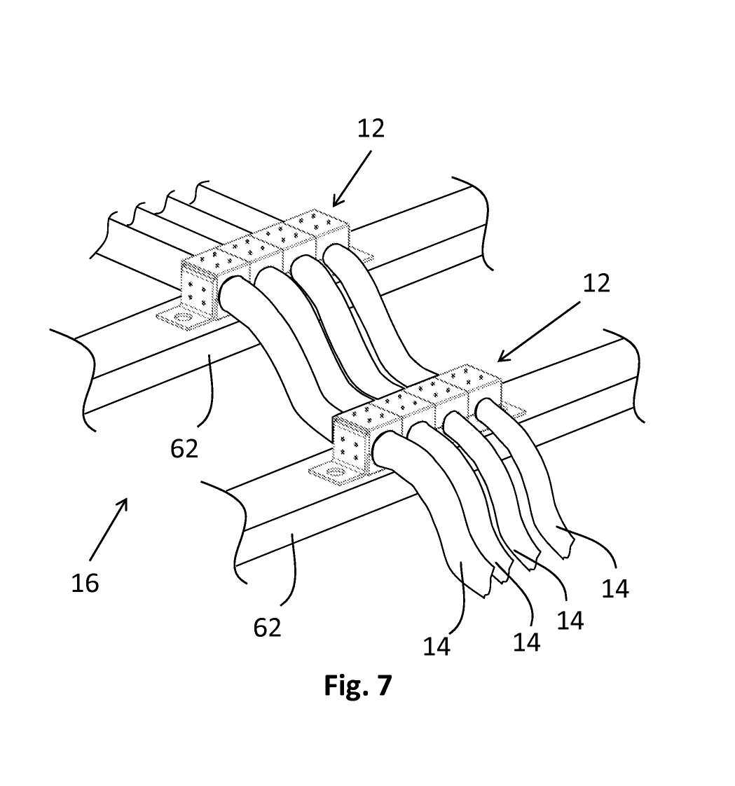

A recess 54 is formed in the manner of a slit on the upper first body part 24 on both the left and right side face 46, 48. Fastening means 56 are furthermore provided in the form of a double-angled retaining plate (illustrated in FIGS. 5 and 6), which are inserted at one end in the recesses 54 (see FIGS. 3 to 7). The retaining plates are provided with bores 58 which are arranged corresponding to the position of the plug pins 50 so that the plug pins 50 can sink in the bores 58 and the retaining plates can adjoin with a flat surface against the side faces 46, 48. The retaining plates have at one end a fastening bore 60 with which they can be screwed onto a frame part 62 of the frame structure 16 (see FIG. 7). The clamps 10 are provided with an elastic coating 64 which is applied to the semi-cylindrical recesses 34, 36. This can also be a rubber coating here which is arranged in the hollow spaces 20 to protect the hoses and cables 14 or even for a more solid play-free seat therein. An adhesive coating of an adhesive material can also be applied here instead with the same function.

FIGS. 3 and 4 show how a clamping assembly 12 is provided with 4 clamps 10 having the same external dimensions but having hollow spaces 20 of different diameters wherein the individual bodies 18 of the clamps 10 were fitted to one another by their side faces so that the left side faces 46 were each pushed against a right side face 48 of the clamp 10 next to it, wherein the left side face 46 of the left clamp 10 and the right side face 48 of the right clamp 10 (each with reference to FIG. 4) are connected to the fastening means 56, which were inserted into the corresponding recesses 54 (slits). A corresponding combination of the clamping assembly 12 from FIGS. 3 and 4 is illustrated in FIG. 7 where four hoses or cables 14 were fastened with the clamps 10 to the frame parts 62 of a frame structure. The hoses or cables 14 are for this each placed in the recess 34 of a lower second body part 26. The upper first body part 24 is then fitted onto the lower second body part 26. The upper and lower body part 24, 26 now form the respective body 18 of a clamp 10, wherein the relevant body 18 can be fitted together at its side parts 46, 48, as described above, to its adjoining body 18. The fastening plates 56 are thereby screwed on to the frame parts 62 so that the individual clamps 10 or their bodies 18 are additionally held together at the sides and are securely held on the frame part 62 by the upper angle on the retaining plate which engages in the recesses 54 of the bodies 18 arranged at the sides.

Further combinations are also conceivable, of which here only one is shown by way of example with reference to the embodiment in FIGS. 5 and 6. Here, there are 8 bodies 18 arranged side by side and one above the other, in the same way as already described above regarding the clamping assembly 12 of FIGS. 3 and 4 and FIG. 7. Here in addition only the upper side faces 42 of the bodies 18 underneath are push-fitted together with the lower side faces 44 of the side faces 46 arranged above. The fastening means 56 are here designed as retaining plates which have a longer center part and thereby vertically span each two side faces 46 and 48 of the bodies 18 on the outside, wherein the retaining plates are each inserted by their upper end in the slit-like recesses 54 of the side faces 46, 48 of the upper outer bodies 18 for fastening the clamping assembly 12 in an 8-clamp combination (the right retaining plate in the FIGS. 5 and 6 is for illustration reasons not inserted completely). The bodies 18 are hereby spanned both at the sides and from above downwards by the retaining plates. Also here bodies 18 are shown by way of example with cylindrical hollow spaces 20 of different diameter. Further combinations with more or fewer bodies 18 with larger or smaller diameters of the hollow spaces 20 and in several rows side by side or one above the other (three or more rows one above the other as well as 5 or more rows side by side or fewer than four rows side by side are also conceivable throughout and should be covered herewith.

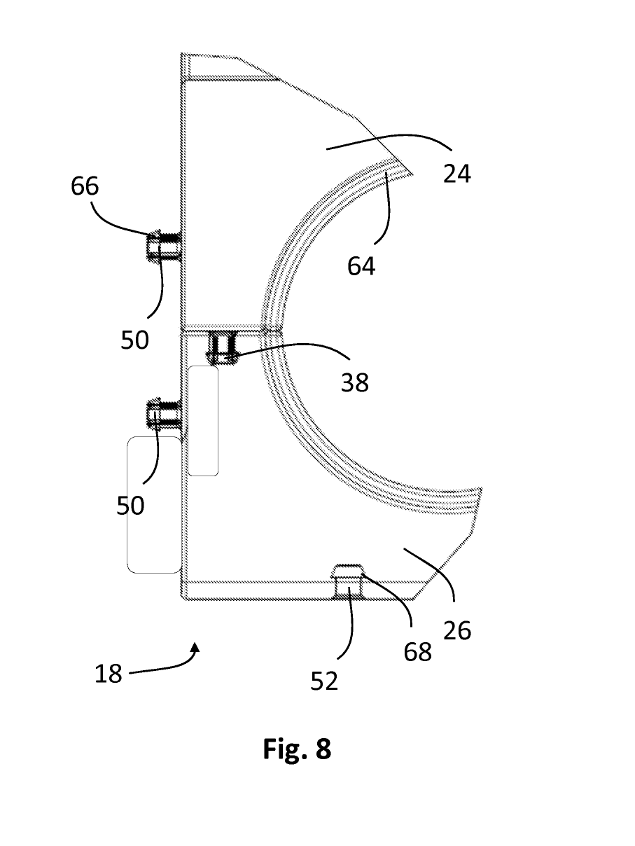

FIG. 8 shows an enlarged section of a body 18 in front side view for better illustrating the design of the plug posts 38, plug pins 50 and the plug bores 52, wherein the plug bores 36 are not shown here but are designed similar to the plug bores 52. As can be seen in FIG. 8, the plug posts/pins 38, 50 are provided with a bead or barb 66. The plug bores 52 and also 36 (not shown in FIG. 8) are formed complementary to the shape of the plug posts/pins 38, 50, so that a shoulder 68 is provided there which forms a detent edge for the bead or barb 66 formed on the plug posts/pin 38, 50. Plug connections of this type are known as “snap-fit” or detent connections.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

What is claimed is:

1. Clamp for a clamping assembly for fastening hoses or cables to a frame structure, the clamp comprising:
a cube-like body which peripherally surrounds a cylindrical bore which is opened at its end faces and which has a central axis, wherein the body is divided into a first body part and a second body part, the first body part having a first separating face, the second body part having a second separating face which engages the first separating face, each separating face having a semi-cylindrical recess formed therein, the body parts are joined together at the separating faces by means of a push-fit connection, the body having a first side face which is parallel to the axis, the body having a second side face which is parallel to the axis and opposite from the first side face;
plug pins which project from the first side face; and
plug bores formed in the second side face.

2. The clamp of claim 1, wherein:
plug posts are formed on one of the separating faces on a side of the semi-cylindrical recess, and plug recesses are formed on the other separating face, each plug recess being arranged to receive a corresponding one of the plug posts in order to connect the two body parts.

3. The clamp of claim 2, wherein:
the plug posts engage in the plug recesses.

4. The clamp of claim 1, wherein:
a slit is formed on a side face which is joined to one of the separating faces, the slit being elongated in a direction which is parallel to the axis of the hollow space, and the slit being adapted to receive a fastening member.

5. The clamp of claim 4, wherein:
the fastening member comprises a double-angled retaining plate, the plate having a first end which is inserted into the slit, and having a second end which is fastened to a frame structure.

6. The clamp of claim 1, wherein:
the semi-cylindrical recesses are coated with an elastic coating.

7. The clamp of claim 1, wherein:
the semi-cylindrical recesses are coated with an adhesive coating.

8. A clamping assembly for fastening hoses or cables, the clamping assembly comprising:
a frame structure; and
a plurality of clamps arranged adjacent to each other and supported on the frame structure, each clamp comprising:
a cube-like body which surrounds a cylindrical bore which is open at its end faces and which has a central axis, wherein the body is divided into a first body part and a second body part, the first body part having a first separating face, the second body part having a second separating face which engages the first separating face, each separating face having a semi-cylindrical recess formed therein, the body parts are joined together at the separating faces by means of a push-fit connection, the body having a first side face which is parallel to the axis, the body having a second side face which is parallel to the axis and opposite from the first side face, plug pins projecting from the first side face, and plug bores formed in the second side face.

9. The clamping assembly of claim 8, wherein:
adjacent clamps are push-fitted together so that plug pins on one clamp are received by plug bores in an adjacent clamp.

10. The clamping assembly of claim 8, wherein:
different ones of the clamps have cylindrical bores with different diameters.

11. The clamping assembly of claim 8, wherein:
a plurality of hoses or cables are fastened to a frame structure, each one of hoses or cables is guided in the cylindrical hollow space of one of the clamps.

12. The clamping assembly of claim 8, wherein:
a slit is formed on a side face which is joined to one of the separating faces, the slit being elongated in a direction which is parallel to the axis of the hollow space, and the slit being adapted to receive a fastening member.

13. The clamping assembly of claim 12, wherein:
the fastening member comprises a double-angled retaining plate, the plate having a first end which is inserted into the slit, and having a second end which is fastened to the frame structure.
